(19) United States
(12) Patent Application Publication
(10) Pub. No.: US 2006/0178912 A1
(43) Pub. Date: Aug. 10, 2006

(54) Computerized system for developing weight-loss plan

(76) Inventors: Cindy J. Ferraro, Huntingdon Valley, PA (US); Stanley Gitt, Huntingdon Valley, PA (US)

Correspondence Address: BLANK ROME LLP, 600 NEW HAMPSHIRE AVENUE, N.W., WASHINGTON, DC, 20037, US

(21) Appl. No.: 11/315,583

(22) Filed: Dec. 23, 2005

Related U.S. Application Data
(60) Provisional application No. 60/638,106, filed on Dec. 23, 2004.

(51) Int. Cl. G06F 19/00

(52) U.S. Cl. 705/3

(57) ABSTRACT

A weight loss program can be implemented at least partially on a Web server or other computing device. Patient data are input into the computing device. The computing device determines a weight-loss program, including a prescription, and provides the weight-loss program and the prescription to a physician for review before they are provided to the patient.

### REFERENCE TO RELATED APPLICATION

The present application claims the benefit of U.S. Provisional Patent Application No. 60/638,106, filed Dec. 23, 2004, whose disclosure is hereby incorporated by reference in its entirety into the present disclosure.

### FIELD OF THE INVENTION

The present invention is directed to a method for developing a weight-loss program in which at least part of the method is performed automatically on a Web server or other computing device.

### DESCRIPTION OF RELATED ART

In the context of physical health, weight loss is the process of losing body weight, typically by losing fat. To achieve weight loss, more calories must be expended than taken in. This can be achieved by reducing the amount of food consumed, increasing physical activity or a combination of the two. For healthy weight loss, most experts recommend a combination of healthy eating patterns and regular physical exercise.

However, an improperly prepared program of weight loss can have risks. For example, yo-yo dieting, also known as weight cycling, is a repeated loss and gain of body weight due to excessive dieting. The dieter is initially successful in the pursuit of weight loss but is unsuccessful in maintaining the loss long-term and begins to gain the weight back. The dieter then seeks to lose the regained weight, and the cycle begins again. Also, fad diets can be ineffective or even dangerous.

To avoid the above risks, a physician should typically prepare a weigh-loss program customized for a specific patient. However, it can be difficult for a physician to do so entirely manually.

### SUMMARY OF THE INVENTION

It is therefore an object of the invention to provide a technique for preparing a weight-loss program that is at least partially automated.

To achieve the above and other objects, the present invention is directed to a technique for preparing a weight-loss program that can be implemented at least partially on a Web server or other computing device, which is preferably operated by a company that provides the program (hereafter known as “the service”). Patient data are input into the computing device. The computing device determines a weight-loss program, including a prescription, and provides the weight-loss program and the prescription to a physician for review before they are provided to the patient.

### BRIEF DESCRIPTION OF THE DRAWINGS

A preferred embodiment of the present invention will be set forth in detail with respect to the drawings, in which:

FIG. 1 is a high-level flow chart showing an overview of the invention;

FIG. 2 is a high-level block diagram showing a system on which the preferred embodiment can be invented; and

FIG. 3 is a high-level block diagram showing the interactions between the employee's computers and the servers in the system of FIG. 2.

### DETAILED DESCRIPTION OF THE PREFERRED EMBODIMENT

A preferred embodiment will be set forth in detail with reference to the drawings, in which like reference numerals refer to like elements or steps throughout.

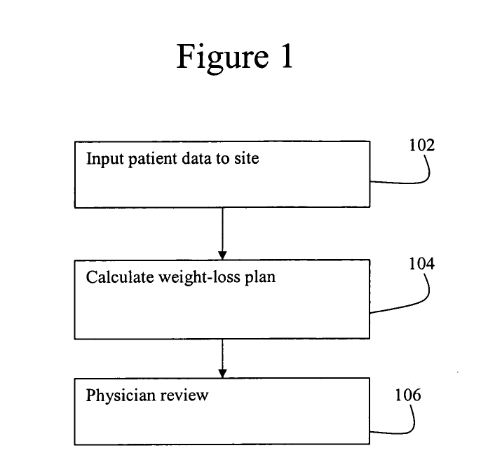

An overview of the process is shown in FIG. 1. In step 102, the patient data are input into a processing device. In step 104, the weight loss plan is automatically calculated from the data input in step 102. In step 106, the weight loss plan determined in step 104 is reviewed by a physician.

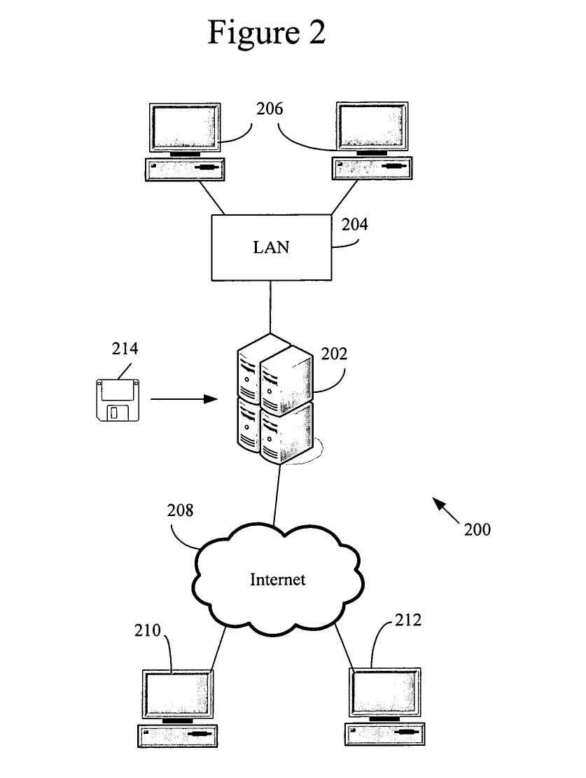

An overview of a system on which the process of FIG. 1 can be implemented is shown in FIG. 2 as 200. The processing device mentioned above can be implemented as one or more servers 202, which host a Web site on which the preferred embodiment is implemented. That site and associated functionality will be described below. The servers 202 are accessible to employees of the service locally over a local area network 204 and employee computers 206. The servers 202 are also accessible to patients and physicians over the Internet 208, patients' computers 210, and physicians' computers 212.

The servers 202 run software for performing the functionality to be described below. The software can be supplied on a permanent storage medium (tape, disk, etc.) 214 or in any other suitable manner.

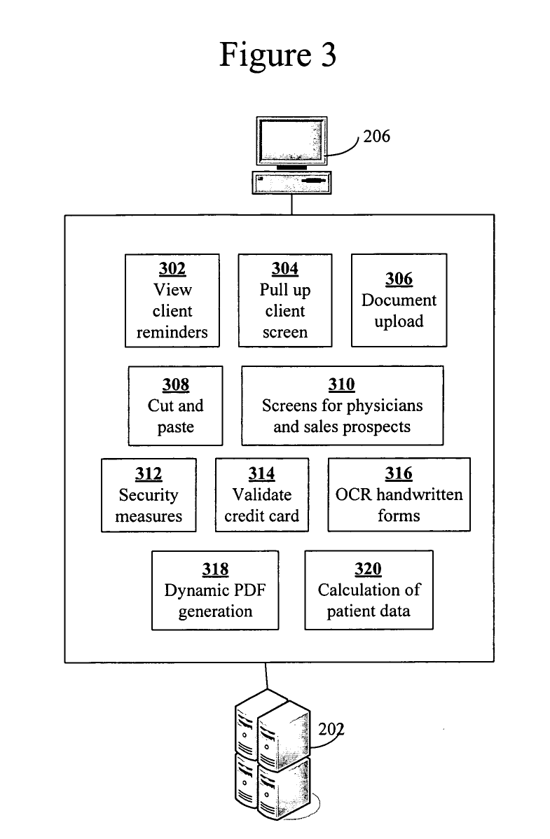

The interaction between the servers 202 and the employee's computers 206 will be described below with reference to FIG. 3.

Once an employee logs in, they are able, in step 302, to see reminders of clients that they need to contact that day and they are able to pull up a list of all of the clients that have been assigned to them. With security levels, the employees are only able to see what have been assigned to them.

In step 304, they can pull up the client screen that includes all of the database fields. This screen also includes a document upload feature and a cut and paste feature. An illustrative (but not limiting) example of a database that can be used in the preferred embodiment is ACT!.

The document upload process in step 306 allows an employee to upload any sort of document to the database—original TIFF enrollment forms, other documents (such as the patient package Word document) and, in some embodiments, sound files, and retrieve them later in their original format. Administration can update and delete these files as needed.

The cut and paste process in step 308 allows an employee to paste in text and save it to the database with a date and description. Administration is also able to update and delete these files.

The servers 202 also display, in step 310, a set of screens for the physicians/sales prospects and integrate them into the system. Once a physician has been “sold,” that physician's status is changed, and that physician is available as the physician for clients.

Also, the system has security measures 312 that restrict certain screens or fields to members of one security group or another. The system itself is password protected.

The site is integrated with a credit-card service such as Quick Commerce Pro to provide credit-card validation 314. Once the customer and credit card fields are filled out, the processor checks and responds with “Approved” or “Declined.”

The site is integrated with an OCR software package that specializes in performing optical character recognition on handwritten forms in step 316.

The site is integrated with ActivePDF Toolkit. It uses the SQL data to create a dynamic PDF file in step 318. Any other suitable tool can be used instead.

Once the initial data entry is finished on the client forms, the calculations happen automatically in step 320 and go into the proper form fields. The calculations will be described in detail below.

An expanded version of the explanation of the preferred embodiment given above with reference to FIG. 1 will now be given.

The patient enrolls in the physician's office upon the recommendation of the physician.

The patient receives the patient information book

The service acquires the patient data (medical history, medications, etc) either on paper forms or electronically. The last page of the data is a medical formal report that is completed by the physician. This insures that the data are accurate and include all medications, dosages, medical history and physician observations.

The patient data then go to data entry if not already in the system (because the certified physician has a terminal).

Upon receipt of the data, the patient care department (known in retail as customer service) calls and e-mails the patient to “welcome” them and let them know the approximate time it will take before they receive their materials and prescriptions. They will answer simple non medical questions on over all program information and make the patient feel comfortable and confident.

The data are processed using the software (described below) to assist the medical team in creating a plan for that patient.

The first part of the plan includes a written prescription recommendation for medications and/or non-stimulant natural substances, and the decision is made by the service's team of physicians. This prescription is faxed or e-mailed to physicians for their signature indicating approval of the recommendation. It is at this juncture that the physician has the ability to agree with or disagree with the recommendation. The recommendation is typically accepted, since the service's staff physician reviews each patient's chart.

The patient's physician signs the prescription, and then a staff member faxes this to the service. At that point it is reviewed again and then sent along to a pharmacy to be filled and sent (a prescription requires the patient's signature to be delivered) to the patient.

Concurrently, the second part of the plan is created by the counseling department. This becomes a document that is sent to the patient. This patient plan includes but is not limited to: welcoming and directive information along with counselor assignment; a custom menu; a custom snack list; a proprietary software produced body composition analysis along with a recommendation for changes and projected results; the parameters of an exercise program; and counseling instructions and contact information.

While this is occurring, the counseling team is briefed as to the patient's needs and assignments discussed. The counselor assignment is determined by four factors: medical condition, amount of weight to lose, physician observations regarding mental state of the patient and geographic area.

Once connected with their counselors, the patient is instructed to make their 1 month appointment with the physician's office. At that visit, with the physician or staff, the patient will be weighed, measured, body fat calculated, blood pressure, resting heart rate and overall well being. This is to be faxed or downloaded to the site. Between the service's counseling team and the physician or staff, the patient is well cared for in all aspects of their weight loss and maintenance.

Once the patient has connected with his/her counselor they enter a two phase counseling process.

Phase One—Initial counseling which includes but is not limited to: Web based interactive training including documents and questionnaires; an initial counseling call to be certain the patient is comfortable with the plan; and assignment of an e-mail counselor if possible.

Phase Two—Weekly phone counseling (more if necessary); daily (7 days a week) e-mail counseling

Lastly, the service works with the physicians and patients in a web based data base. Access to this base will allow the physician to review all interactions between the service and the patient. The physician is able to see their progress reports, interactive e mail which includes daily menus and notes between the service and the patient. The physician will be able to check on the patient's progress at any time of day or night.

The physician certification process will now be described.

Physicians can be contacted to introduce the program by various methods, which will be familiar to those skilled in the art. Once a physician is accepted as a certifiable providing physician, the following process will include, but is not limited to, the following.

The physician (or practice) will sign a contract defining their responsibilities and the service's responsibilities to them and their patients. This must be returned to the service to start the process.

Each physician in the practice (if more than one) will need to submit his/her DEA number, expiration date and the first page of their malpractice insurance for the service's records. That information is sent to the pharmacy for their records.

The pharmacy will check each prescription, its signature and the DEA number. The recommendations produced by the service for the prescription must be signed by a certified physician or PA registered with the service and the pharmacy. This process is defined above in the enrollment process.

The service will then send via mail the start up package, which includes all the tools the physician (practice) needs to start enrolling patients. This package will include, but is not limited to: a welcome letter and directives; a provider manual (a step-by-step guide to implementation); a master copy of the enrollment, re-enrollment and other forms; ten patient information books (which includes data acquisition info); brochures and marketing materials; one each of all supplements that the service manufactures or provides for their inspection; and signs (wall signs for their office—a set of 4).

The physician or practice will be contacted and encouraged to set up an “in-service” training with the counseling department, the physician[s] and their selected staff. This training is done via ‘speaker-phone’ and can be up to two hours.

The physician (practice) will arrange for a phone conference with one of the service's in-house physicians to offer training on the pharmaceuticals and herbaceuticals that the service will potentially recommend for their patients. Many physicians do not require this step.

The physician (practice) must then submit their patient list on labels to enable the service's marketing team to prepare for the first ‘direct mailing’ to their patient base announcing the certification and the program. The physician may actively participate in the creation of the mailings to their patients. In the event they do not wish to do so, the service will prepare those letters for their review and editing.

A working website, which can be implemented on the servers 202, will now be described. The working website was developed to allow the service's medical team, its counseling team, its staff, its executive officers and its providing physicians to quickly add, review and/or document and verify information regarding a patient from anywhere in the world, any time of day or night. This site was developed for inner office use and is not connected in any way to the ‘public’ site where patients visit to review the potential of the program and enrolled patients go to access the interactive counseling program.

The site does the following; however, it is not limited to the following tasks.

The site receives data, manually and electronically (e.g., MS Word format). It can use a signature pad so that the service can maintain an exact copy of patient signatures on forms that specifically require that degree of documentation.

The site processes patient credit card, debit card and check payments electronically and deposits the payments to the service's financial institutions.

The site creates payment reports to vendors and patients to expedite bookkeeping and accounting.

The site searches and sorts data to create reports.

The site performs the following calculations based in input data. Body analysis data are calculated, based on enrollment data, and include: body mass ratio, pounds of lean muscle mass, percentage of body fat and an optimal range for the specific individual of that percentage, pounds of body fat and an optimal range of body fat for that specific individual, and suggested pounds of body fat to lose.

A body analysis is also performed, including the following. Basal Metabolic Rate (BMR) is the number of calories burned by the patient's lean body mass in a 24 hour period at complete rest. Specific Dynamic Action of Foods (SDA) is the number of calories required to process and utilize consumed foods. Resting Energy Expenditure (REE) is the sum of BMR and SDA and represents the number of calories that the patient's body requires in a 24 hour period at complete rest. Activities of Daily Living (ADL) is the approximate number of calories burned by the patient's body during normal daily activities. Calories Burned by Exercise is the number of calories burned by the exercises selected by the patient. Also included, is the level and intensity of the patient's activities. Total Caloric Requirements are the total intake of calories required by the patient. Program Recommendation Total Caloric Intake is a calculated value of the caloric supplement required to achieve weight loss of approximately 2 pounds per week.

The site makes the following recommendations based on the data. Medications or non stimulating substances to assist in weight loss are recommended. Patient types (medical or non medical) are defined in accordance with that recommendation.

In certain cases, the site rejects the use of appetite suppressants and provides a notification that the patient must be reviewed manually by the service's staff medical doctors. Medical conditions, medications and other conditions will “red flag” the patient so that the patient's chart must be manually reviewed. Examples include renal disorders and cardiovascular diseases.

The recommendations further include dosages of the above substance, physical activity to achieve the goal (body fat loss or gain), a metabolic menu based on data provided by patients (food dislikes and sensitivities), proteins (to achieve goal), carbohydrates and fats.

The site prepares a patient plan based on the data. A 10-14 page letter is prepared, including the following: a welcome message, counseling assignment, personal instructions, a menu, a snack list, an exercise physiology report and recommendation, counseling instructions, e-mail counseling directions, and other directions specific to the patient's needs. The site prints that patient plan and has the capability to print envelopes for conventional mail and to send e-mail to the patient.

The site has manual (print, fill out and fax) and electronic enrollment forms, which can be downloaded by the patient (e.g., in Adobe Acrobat format).

The site stores correspondence, notes, and other information in persistent storage. Ongoing notes can be created and continually updated to quickly review this correspondence with a patient and their counselor weekly. The site stores e mail correspondence between patient, counselor, doctor and significant others.

The site just described is used in the following manner.

The data from the providing physician are electronically sent to the site or manually entered once the patient is enrolled in the program. From the point of data entry the work on the site proceeds in the following manner.

The data entry department reviews the entry to be certain all the data are entered properly. This forms an electronic chart on the patient. If not, the missing data are posted so that the team is able to locate the data. All faxed or hard copies of charts are stored in the electronic chart.

The accounting staff processes the patient payment through the site; the payment is electronically transferred to a financial institution. This happens before any other work is complete. The site is able to process checks, credit or debit cards and other forms of payment such as money orders.

The medical team is then alerted that there is a new patient to review. That review is completed as the data are run through the software which will enable the medical team to see the approximate parameters of the patient's body composition along with the patient's complete medical history including their medications and present condition. The site provides the medical team with the providing physician's observations as well. The site allows the doctor to work from anywhere in the world via the Internet.

The recommendation for medication and or supplements is then provided by the site, using software formulas detailed below.

In the event the patient has extensive or contraindicating medical history or information, a red flag will come up by the software to alert the medical team that the patient must be reviewed manually. It also blocks the software from creating recommendations without a manual override. This part of the software was built by adding all contraindicating conditions and medications so as to safeguard the patient. If there is no such condition, the medical team then will approve the patient to be packaged by the rest of the team.

Once alerted via the site, the counseling team takes over to create the rest of the patient's plan. They software will create the menu, the snack list, and the parameters of the exercise program along with several custom recommendations for that patient. Each patient is reviewed individually by a live person, and the balance of the plan is completed.

Reorder forms are electronically part of the site so that a counselor may enter a reorder (money and all) at any time.

Electronic searching ability allows a staff member to search and sort from various categories.

The site also has the ability to create an accounting (for payments) for the compensation of the providing physicians, vendors, and the pharmacy to create a report showing the money owed to the pharmacy for each patient's prescription.

Another feature of the present invention, at least in a preferred embodiment, is that once a patient's data are complete and after the software has operated on those data, a cardiologist looks at the data. The cardiologist can be provided not only with a text report, but also with the patient's EKG converted from fax to an e-mail format (e.g., TIFF or JPEG).

The software uses the following formulas:

Caloric Energy Equation

BMR—Basal Metabolic Rate—the amount of energy your body needs to function at rest.

The site uses the Harris-Benedict formula:
Adult male: 66+(6.3×body weight in lbs)+(12.9×height in inches)−(6.8×age in years)
Adult female: 655+(4.3×weight in lbs)+(4.7×height in inches)−(4.7×age in years)

*Ex: 1426

SDA—Specific Dynamic Action of Foods—the number of calories required to process and utilize consumed foods

10% of the BMR

Ex: 142

REE—Resting Energy Expenditure—# of calories your body requires in a 24 hour period at complete rest

Sum of BMR and SDA

Ex: 1568

ADL—Activities of Daily Living—approximate # calories you burn during normal day activities

20% of REE

Ex: 313

* the above example is taken from a female, 20 years old, 5′6″ in height and 140 lbs.

Personal Body Composition Analysis

BMR: see above formula

Percentage of body fat—done at the doctor's office with machine

**Ex: 23%

The optimal range of percent of Body Fat:

adult male: 10-18%

adult male above the age of 55: 10-22%

adult female non-menopausal: 18-25%

Ex: 18-25%

adult female menopausal: 18-28%

Pounds of Body fat: total current body weight×percentage of body fat

Ex: 32.2 lbs

The desired range of pounds Body Fat: total current body weight×the optimal range of percent Body Fat

Ex: 25-35

Pounds of Lean Muscle Mass: total current body weight−(minus) pounds of Body Fat

Ex: 107.8

Suggested pounds of Body Fat to lose: current pounds of Body Fat−(minus) desired range of pounds of Body Fat.

Ex: 2.8-7.2

**The numbers above are an example taken from an adult female (non-menopausal) who weighs 140 lbs and has 23% Body Fat.

Target Heart Rate

MHR—Maximum Target Heart Rate

Male:

220—age (Non-Athletic)

205—age/2 (Fit)

Female:

226—age (Non-Athletic)

211—age/2 (Fit)

***Ex: 190

THR—Target Heart Rate

THR range of 60% to 85% of your MHR is recommended for improving heart lung endurance and burn fat (exceeding 20 minutes of exercise)

Ex: 114-161 bpm (beats per minute)

*** Example taken from a female 30 years old, non-athletic

Diethylpropion is prescribed in the following quantities:

½ tab at 11 am and ½ tab at 5 μm—heights up to 5′ or weight loss of less than 10 lbs.

1 tab at 11 am and ±2 tab at 5 μm—heights between 5′1″ and 5′3″ or weight loss between 10-18 lbs, who feel hungrier in the mornings and afternoons.

½ tab at 11 am and 1 tab at 5 μm—heights between 5′1″ and 5′3″ or weight loss between 10-18 lbs, who feel hungrier in the evenings and night.

1 tab at 11 am and 1 tab at 5 μm—heights between 5′4″ and 5′7″ or weight loss between 19-30 lbs.

1½ tabs at 11 am and 1 tab at 5 μm—heights between 5′7″ and 5′9″ or weight loss between 30-50 lbs, who feel hungrier in the am or afternoon.

1 tab at 11 am and 1½ tabs at 5 μm—heights between 5′7″ and 5′9″ or weight loss between 30-501 bus, who feel hungrier in the evening or night.

1½ tabs at 11 am and 1½ tabs at 5 μm—heights between 5′7″ and 5′9″ or weight loss between 30-50 lbs. For pts that feel hungry at all times

2 tabs at 11 am and 2 tabs at 5 μm—heights above 5′9″ or weight loss of more than 50 lbs.

The amount of weight to lose supersedes height in determining the amount to prescribe.

While a preferred embodiment has been set forth above, those skilled in the art will readily appreciate that other embodiments can be realized within the scope of the invention. For example, numerical examples are illustrative rather than limiting, as are mentions of specific software products, file formats, and medications. Therefore, the present invention should be construed as limited only by the appended claims.

What is claimed is:

1. A method for developing a weight-loss program, comprising:
(a) inputting patient data into a server;
(b) determining automatically, in the server, a weight-loss program including a prescription; and
(c) providing the weight-loss program and the prescription determined in step (b) to a physician for review before they are provided to the patient.

2. The method of claim 1, further comprising:
(d) storing, in the server, information on the patient's progress; and
(e) making the information stored in step (d) available to the physician.

3. The method of claim 2, wherein at least one of steps (a), (c), and (e) is performed over the Internet.

4. The method of claim 1, wherein the patient data input in step (a) comprise the patient's sex, weight, height and age.

5. The method of claim 4, wherein the patient data input in step (a) further comprise a medical history of the patient and an indication of any medications that the patient is taking.

6. The method of claim 5, wherein the patient data input in step (a) further comprise physician observations about the patient.

7. The method of claim 4, wherein step (b) comprises calculating a basal metabolic rate from the patient's sex, weight, height and age.

8. The method of claim 7, wherein the patient data input in step (a) further comprise a percentage of body fat.

9. The method of claim 8, wherein step (b) comprises determining an optimal range of percentage of body fat and a suggested number of pounds of body fat to lose.

10. The method of claim 9, wherein step (b) further comprises determining the prescription from the suggested number of pounds to lose and the patient's height.

11. An article of manufacture comprising:
a computer-readable storage medium; and
code stored on the computer-readable storage medium, the code controlling a server to perform the following:
(a) receiving and storing an input of patient data;
(b) determining automatically, a weight-loss program including a prescription; and
(c) providing the weight-loss program and the prescription determined in step (b) to a physician for review before they are provided to the patient.

12. The article of manufacture of claim 11, wherein the code comprises code for controlling the server to perform the following:
(d) storing, information on the patient's progress; and
(e) making the information stored in step (d) available to the physician.

13. The article of manufacture of claim 12, wherein the code comprises code for controlling the server to perform at least one of steps (a), (c), and (e) over the Internet.

14. The article of manufacture of claim 11, wherein the patient data input in step (a) comprise the patient's sex, weight, height and age.

15. The article of manufacture of claim 14, wherein the patient data input in step (a) further comprise a medical history of the patient and an indication of any medications that the patient is taking.

16. The article of manufacture of claim 15, wherein the patient data input in step (a) further comprise physician observations about the patient.

17. The article of manufacture of claim 14, wherein the code controls the server to perform step (b) by calculating a basal metabolic rate from the patient's sex, weight, height and age.

18. The article of manufacture of claim 17, wherein the patient data input in step (a) further comprise a percentage of body fat.

19. The article of manufacture of claim 18, wherein the code controls the server to perform step (b) further by determining an optimal range of percentage of body fat and a suggested number of pounds of body fat to lose.

20. The article of manufacture of claim 19, wherein the code controls the server to perform step (b) further by comprises determining the prescription from the suggested number of pounds to lose and the patient's height.

21. A computing system for developing a weight-loss program, comprising
a server for (a) inputting patient data into a server and (b) determining automatically, in the server, a weight-loss program including a prescription; and
a communication device, in communication with the server, for (c) providing the weight-loss program and the prescription determined in step (b) to a physician for review before they are provided to the patient.

22. The computing system of claim 21, wherein:
the server stores information on the patient's progress; and
the communication device makes the information stored in step (d) available to the physician.

23. The computing system of claim 22, wherein the communication device comprises a device for communication over the Internet.

24. The computing system of claim 21, wherein the patient data input in step (a) comprise the patient's sex, weight, height and age.

25. The computing system of claim 24, wherein the patient data input in step (a) further comprise a medical history of the patient and an indication of any medications that the patient is taking.

26. The computing system of claim 25, wherein the patient data input in step (a) further comprise physician observations about the patient.

27. The computing system of claim 24, wherein the server performs step (b) by calculating a basal metabolic rate from the patient's sex, weight, height and age.

28. The computing system of claim 27, wherein the patient data input in step (a) further comprise a percentage of body fat.

29. The computing system of claim 28, wherein the server performs step (b) by determining an optimal range of percentage of body fat and a suggested number of pounds of body fat to lose.

30. The computing system of claim 29, wherein the server performs step (b) further by determining the prescription from the suggested number of pounds to lose and the patient's height.
